(19) United States
(12) Patent Application Publication
(10) Pub. No.: US 2013/0314374 A1
(43) Pub. Date: Nov. 28, 2013

(54) TOUCH DETECTING DEVICE AND METHOD USING GROUP IDENTIFICATION

(71) Applicant: Crucialtec Co., Ltd., Chungcheongnam-do (KR)

(72) Inventors: Jae Heung KIM, Gyeonggi-do (KR); Young Jin OH, Gyeonggi-do (KR)

(73) Assignee: CRUCIALTEC CO., LTD., Chungcheongnam-do (KR)

(21) Appl. No.: 13/902,787

(22) Filed: May 25, 2013

(30) Foreign Application Priority Data
May 25, 2012 (KR) 10-2012-0055841

(51) Int. Cl. G06F 3/044

(52) U.S. Cl. CPC G06F 3/044
USPC 345/174; 178/18.06

(57) ABSTRACT

A capacitive type touch detecting device has one or more sensor pattern groups disposed in a row or column direction. A capacitive type touch detecting device for the sensor pattern groups is formed in a single layer, and thus it is possible to reduce production costs, and to simplify a manufacturing process. Further, the capacitive type touch detecting device requires a relatively smaller number of signal wires than a structure in which the signal wires are formed on the respective sensor pads, and thus a space for the signal wires can be minimized.

### CROSS-REFERENCE TO RELATED APPLICATION

This application claims priority to and the benefit of Korean Patent Application No. 2012-55841, filed on May 25, 2012, and all the benefits accruing therefrom under 35 U.S.C. §119, the content of which in its entirety is herein incorporated by reference.

### BACKGROUND

1. Field of the Invention

The disclosure relates to a capacitive type touch detecting device and method, and more particularly, to a capacitive type touch detecting device and a method including one or more sensor pattern groups disposed in a row or column direction.

2. Discussion of Related Art

Touch detecting devices are devices that are touched with a finger or another touching tool based on information displayed by an image display device so as to input an instruction of a user. To this end, the touch detecting device is provided on a front face of the image display device, and converts a touch position directly touched with the finger or the other touching tool into an electrical signal. As a result, an instruction selected at the touch position is received as an input signal.

As types in which the touch detecting device is realized, a resistive type, a photosensitive type, and a capacitive type are known. The capacitive type touch detecting device detects a change in capacitance which is formed by a conductive detection pattern along with another surrounding detection pattern or a ground electrode when a finger or an object is touched, and converts a touch position into an electrical signal.

Conventional capacitive type touch detecting devices are configured so that transverse linear sensor pads and longitudinal linear sensor pads are formed of a layer of expensive indium tin oxide (ITO). A price of a product to which such a capacitive type touch detecting device is applied is increased. Since a process of forming the sensor pads on opposite faces of a substrate located therebetween is required, a manufacturing process is also complicated.

FIG. 1 shows a plane configuration relating to another example of a conventional capacitive type touch detecting device.

The capacitive type touch detecting device shown in FIG. 1 includes sensor pads 5 formed on a single layer. Since wires are connected to respective sensor pads 5, this capacitive type touch detecting device is increased in size, and has a problem that the number of wires is increased in proportion to the number of sensor 5.

### SUMMARY

The disclosure provides a capacitive type touch detecting device and method including one or more sensor pattern groups disposed in a row or column direction.

According to an aspect, there is provided a capacitive type touch detecting device, which includes one or more sensor pattern groups disposed in a row and/or column direction. Each sensor pattern group includes a plurality of sensor pattern sub-groups each of which includes a plurality of sensor pads disposed on the same plane.

For example, each sensor pattern group may include a first sensor pattern sub-group in which the sensor pads are disposed on the same axis, a second sensor pattern sub-group in which the sensor pads are disposed on the same axis as the first sensor pattern sub-group, a first identification pad for identifying a position of the first sensor pattern sub-group, and a second identification pad for identifying a position of the second sensor pattern sub-group. The sensor pads included in the first sensor pattern sub-group are electrically connected to the sensor pads included in the second sensor pattern sub-group.

In an example, each sensor pattern group may further include a third sensor pattern sub-group disposed on the same axis as the first sensor pattern sub-group, and a third identification pad for identifying a position of the third sensor pattern sub-group. The sensor pads included in the third sensor pattern sub-group may be electrically connected to the sensor pads included in the first sensor pattern sub-group.

In another example, each sensor pattern group further includes a third sensor pattern sub-group including a plurality of sensor pads and a fourth sensor pattern sub-group including a plurality of sensor pads electrically connected to the sensor pads of the third sensor pattern sub-groups, and the first identification pad is for identifying the position of the first sensor pattern sub-group and a position of the third sensor pattern sub-group, and the second third identification pad is for identifying the position of the second sensor pattern sub-group and a position of the fourth sensor pattern sub-group.

Further, the sensor pads connected between the first and second sensor pattern sub-groups may be connected by signal wires, and the signal wires may be disposed on the same plane without crossing one another.

Also, the signal wires may be formed of the same material as the sensor pads.

Furthermore, the sensor pads, the first identification pad, and the second identification pad may be formed of a transparent conductive material.

Each sensor pad may output a signal according to a touched state of a touch input tool in response to an alternating current (AC) voltage alternating at predetermined frequencies in a floating state.

The capacitive type touch detecting device may further include a touch detector that detects a touch based on a variation in voltage at each sensor pad.

Further, the first and second identification pads may be electrically connected to the touch detector.

According to the capacitive type touch detecting device, since a capacitive type touch detecting device is formed in a single layer, it is possible to reduce production costs and to simplify a manufacturing process.

Further, the capacitive type touch detecting device requires a relatively smaller number of signal wires than a structure in which the signal wires are formed on the respective sensor pads, and thus a space for the signal wires can be minimized.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 shows a plane configuration relating to a conventional capacitive type touch detecting device;

FIG. 2A shows a configuration of a capacitive type touch detecting device according to an aspect;

FIG. 2B shows a capacitive type touch detecting device installed on a display device according to the aspect;

FIG. 2C shows an equivalent circuit for detecting a touch when the touch occurs;

FIG. 3 illustrates a sensor pattern group of a capacitive type touch detecting device according to another aspect;

FIG. 4 illustrates a sensor pattern group of a capacitive type touch detecting device according to yet another aspect;

FIG. 5 illustrates a sensor pattern group of a capacitive type touch detecting device according to yet another aspect;

FIG. 6 shows a configuration of a capacitive type touch detecting device according to yet another aspect; and

FIG. 7 is a flow chart showing a touch detecting method according to the aspect.

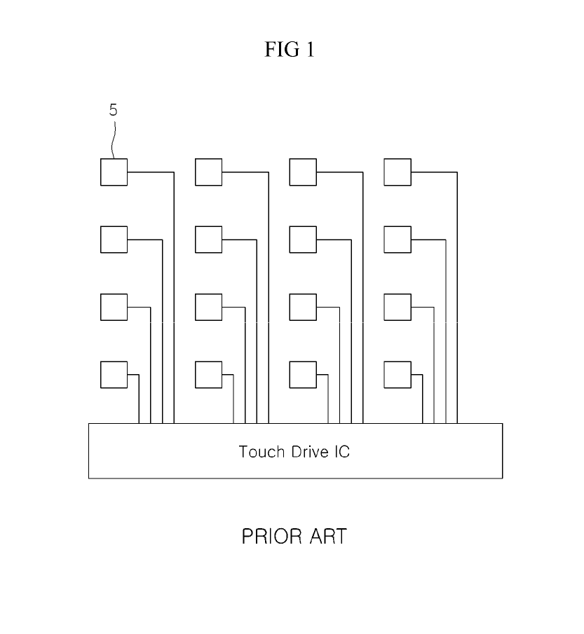

### DETAILED DESCRIPTION OF EXEMPLARY EMBODIMENTS

The present invention now is described below with reference to the accompanying drawings, in which exemplary embodiments of the invention are shown. The invention may, however, be embodied in many different forms and should not be construed as limited to the embodiments set forth herein. Throughout the specification, when a certain portion “includes” a certain component, this indicates that the other components may be further included rather than excluded unless otherwise noted. The terms “unit,” “-or/-er,” and “module” used herein indicate a unit for processing at least one function or operation, which may be implemented by hardware, software or a combination thereof

Throughout the specification, when a certain portion is “connected” or “coupled” to another portion, this may not only be “directly connected” or “coupled” to the other portion, but may also be “indirectly connected” or “coupled” to the other portion with another component interposed therebetween.

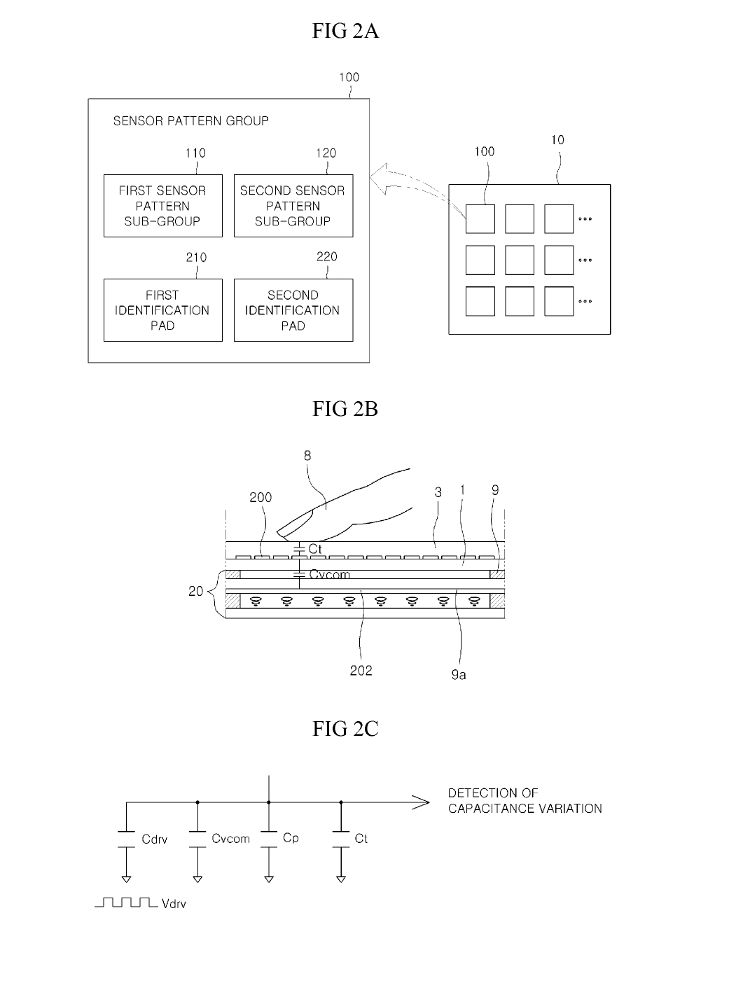

FIG. 2A shows a configuration of a capacitive type touch detecting device according to an aspect. FIG. 2B shows a capacitive type touch detecting device installed on a display device. FIG. 2C shows an equivalent circuit for detecting a touch when the touch occurs.

Referring to FIGS. 2A to 2C, a capacitive type touch detecting device 10 according to an aspect may include one or more sensor pattern groups 100 disposed in a row or column direction.

Each sensor pattern group 100 may includes a plurality of sensor pads 200 disposed on the same plane.

Each sensor pad 200 is an electrode that is patterned on the substrate in order to detect touch input. Touch capacitance Ct is formed between the sensor pad 200 and a touch input tool such as a finger or a conductor. Here, the touch capacitance Ct refers to capacitance formed between the sensor pad 200 and the touch input tool when a touch occurs.

Hereinafter, a method of detecting a touch from a capacitive type touch detecting device will be described.

Referring to FIG. 2B, the touch detecting device is disposed on a display device 20. Thus, the sensor pads 200 are disposed on an upper surface of a substrate 1, and a protective panel 3 for protecting the sensor pads 200 may be attached above the substrate 1. The touch detecting device is adhered to the display device 20 via an adhesive member 9, and an air gap 9a may be formed between the touch detecting device and the display device 20.

As in FIGS. 2B and 2C, when the touch occurs, the capacitance Ct is formed between the finger 8 and the sensor pad 200, and the capacitance Cvcom is formed between the sensor pad 200 and a common electrode 202. Unknown parasitic capacitance Cp is formed on the sensor pad 200.

FIG. 2C corresponds to an equivalent circuit applied to a method of measuring a level shift to detect a touch among capacitive type touch detecting methods.

Referring to FIG. 2C, when the finger touches the sensor pad 200, Cvcom, Cdrv, Cp, and Ct are generated, and the capacitive type touch detecting device detects a variation of Ct, thereby recognizing the touch.

When the touch capacitance Ct is substituted into Equation 1 below, an area touched by a touch input tool may be measured.

$${C}_{t} = ɛ \frac{S 2}{D 2} \qquad Equation 1$$

In Equation 1, c is the permittivity, and may be obtained from a medium between the sensor pad 200 and the finger. If tempered glass is attached to the upper surface of the substrate, the permittivity c can be derived from a value of relative permittivity of the tempered glass multiplied by permittivity of vacuum. The numerator S2 corresponds to an area in which the sensor pad 200 faces the finger. For example, if the finger covers the entire sensor pad 200, S2 corresponds to an area of the sensor pad 200. If the finger covers a part of the sensor pad 200, S2 is reduced by an area in which the sensor pad 200 does not face the finger. The denominator D2 is a distance between the sensor pad 200 and the finger, and corresponds to a thickness of the tempered glass or a different protective panel that is placed on the upper surface of the substrate.

According to Equation 1, Ct is proportional to the area in which the sensor pad 200 faces the finger. As such, a touch occupation rate of the finger relative to the sensor pad 200 may be calculated from Ct. Thus, it is possible to check whether or not a touch signal is detected based on Ct, and to find the area touched by the finger if Ct is substituted into Equation 1 above.

Referring to FIG. 2A again, the sensor pattern group 100 may include a first sensor pattern sub-group 110 in which the sensor pads are disposed on the same axis, a second sensor pattern sub-group 120 in which the sensor pads are disposed on the same axis as the first sensor pattern sub-group 110, a first identification pad 210 for identifying a position of the first sensor pattern sub-group 110, and a second identification pad 220 for identifying a position of the second sensor pattern sub-group 120.

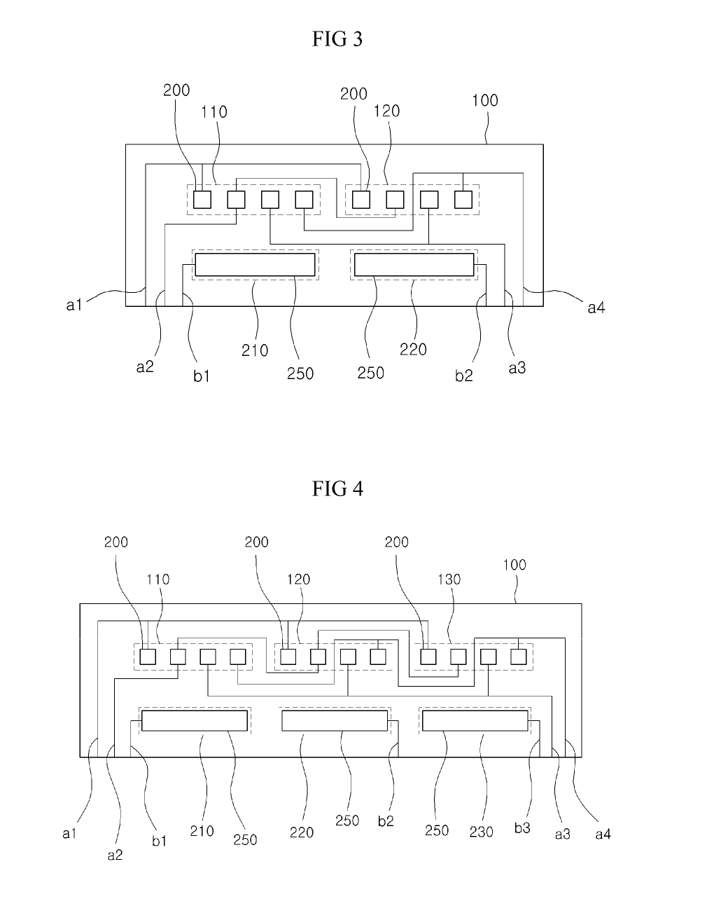

The first sensor pattern sub-group 110 may correspond to the first identification pad 210, and the second sensor pattern sub-group 120 may correspond to the second identification pad 220. Here, the first sensor pattern sub-group 110 may be disposed at a left or right side of the first identification pad 210, and the second sensor pattern sub-group 120 may be disposed at a left or right side of the second identification pad 220. Further, the sensor pads belonging to the first sensor pattern sub-group 110 may be connected to the sensor pads belonging to the second sensor pattern sub-group 120 and corresponding to the sensor pads belonging to the first sensor pattern sub-group 110, which will be described with reference to FIG. 3.

the sensor pads connected between the first and second sensor pattern sub-groups 110 and 120 may be connected by signal wires (not shown). In this case, the signal wires are disposed on the same plane without crossing.

Further, the sensor pads 200 may be connected to a touch detector (not shown) to be described below by the signal wires.

Here, the signal wires may be formed of the same material as the sensor pads 200. For example, if the sensor pads 200 are formed of a transparent conductive material such as indium tin oxide (ITO), the signal wires may also be formed of a transparent conductive material.

Further, the sensor pattern group 100 may include a third sensor pattern sub-group 130 disposed on the same axis as the first sensor pattern sub-group 110, and a third identification pad 230 for identifying a position of the third sensor pattern sub-group 130. The third sensor pattern sub-group 130 may correspond to the third identification pad 230, and be connected to the sensor pads belonging to the first and second sensor pattern sub-groups 110 and 120, which will be described with reference to FIG. 4.

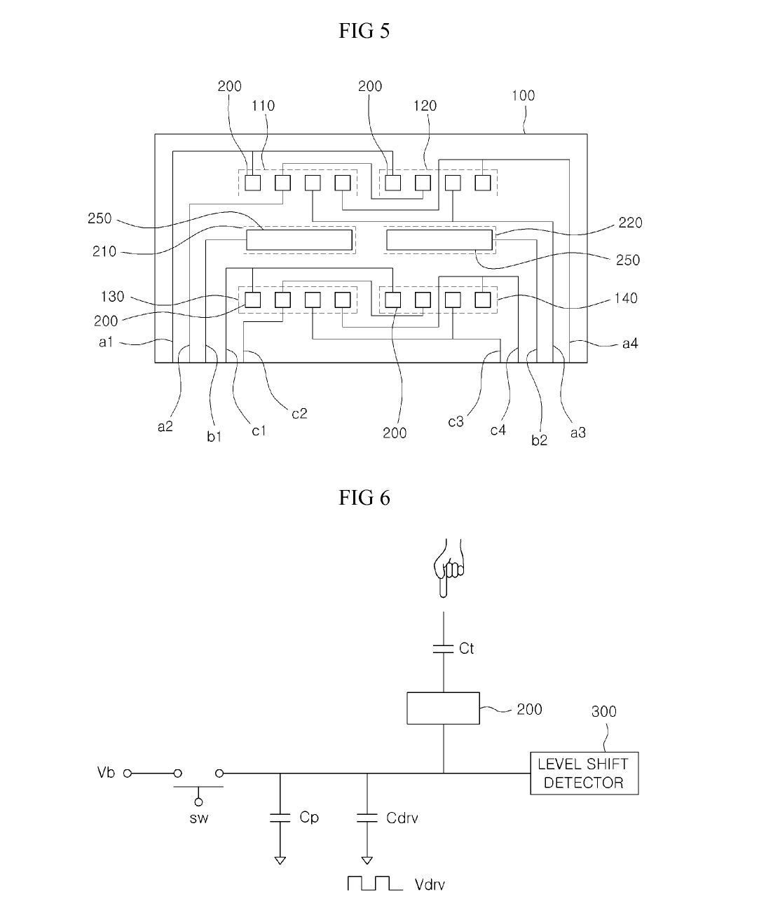

Further, the sensor pattern group 100 may further include a fourth sensor pattern sub-group 140 including sensor pads disposed at the right side of the second sensor pattern sub-group 120, in addition to the third sensor pattern sub-group 130 including sensor pads disposed at the right side of the first sensor pattern sub-group 110. Here, the sensor pads belonging to the third sensor pattern sub-group 130 may be connected to the sensor pads belonging to the fourth sensor pattern sub-group 140 and corresponding to the sensor pads belonging to the third sensor pattern sub-group 130, which will be described with reference to FIG. 5.

The capacitive type touch detecting device according to the aspect may further include a touch detector (not shown).

When a touch occurs, the touch detector may detect the touch based on a variation in voltage at the sensor pads 200 and the identification pads 210 and 220. Here, the touch detector may be connected to each of the sensor pad and the identification pads by the signal wires.

Further, the touch detector may calculate a touch area of each of the sensor and identification pads based on the voltage variation at each of the sensor and identification pads, and then calculate touch coordinates on a touchscreen.

Since the sensor pads belonging to the first and second sensor pattern sub-groups 110 and 120 are connected, it is not easy to calculate the touch coordinates based on only the voltage variation at each sensor pad. Thus, the touch detector detects both the touch to each sensor pad and the touch to each identification pad to more accurately calculate the touch coordinates.

That is, according to the aspect, when the touch occurs, the touch area is detected by the voltage variation. However, it is possible to find to which one of the sensor pattern sub-groups the sensor pad at which the touch occurs belongs from the voltage variation of each identification pad.

The sensor pads belonging to the first sensor pattern sub-group 110 may be electrically connected to the sensor pads that belong to the second sensor pattern sub-group 120 and correspond to the sensor pads belonging to the first sensor pattern sub-group 110 as described below. First, when the touch occurs at the sensor pad of the first sensor pattern sub-group 110, the touch detector detects the touch area using the voltage variation at the sensor pad of the first sensor pattern sub-group 110. However, since one of the sensor pads of the first sensor pattern sub-group 110 is electrically connected to one of the sensor pads of the second sensor pattern sub-group 120, it is not easy to know to which one of the sensor pattern sub-groups the sensor pad at which the touch occurs belongs.

Thus, the touch detector obtains the voltage variation at the sensor pad, and then can know to which one of the sensor pattern sub-groups the sensor pad at which the touch occurs belongs using the voltage variation at the first identification pad 210 identifying the position of the first sensor pattern sub-group 110 and the second identification pad 220 identifying the position of the second sensor pattern sub-group 120.

For example, when the sensor pads belonging to the first and second sensor pattern sub-groups 110 and 120 are disposed on an x axis, and when the first and second identification pads 210 and 220 are disposed near the respective sensor pattern sub-groups, the touch detector may calculate touched x-axial coordinates using the voltage variation at each sensor pad. In this case, since the sensor pads belonging to the first sensor pattern sub-group 110 are connected to the sensor pads belonging to the second sensor pattern sub-group 120 and corresponding to the sensor pads belonging to the first sensor pattern sub-group 110, the x-axial coordinates corresponding to the two sensor pads may be calculated.

Then, the touch detector may identify the touched sensor pattern sub-group using the voltage variation at each identification pad. As such, the touch detector may calculate the x-axial coordinates that are actually touched out of the two x-axial coordinates.

Since the capacitive type touch detecting device is formed in a single layer, it is possible to reduce costs required to form a layer of expensive ITO. Since the sensor pads and the signal wires are formed on the same plane, a manufacturing process can also be simplified.

Further, since the capacitive type touch detecting device is configured so that the plurality of sensor pads included in the sensor pattern group 100 are connected to one another, the capacitive type touch detecting device requires a relatively smaller number of signal wires, compared to the related art in which the signal wires are formed on the respective sensor pads, and thus can reduce a space for the signal wires.

FIG. 3 illustrates a sensor pattern group of a capacitive type touch detecting device according to another aspect.

A sensor pattern group 100 included in a capacitive type touch detecting device according to another aspect may include a plurality of sensor pads 200 and a plurality of identification pads 250. For example, as shown in FIG. 3, the sensor pattern group 100 may include the sensor pads 200 and the identification pads 250 disposed on the same plane.

Each sensor pad 200 outputs a signal according to a touch in response to an alternating current (AC) voltage in a floating state after electric charges are charged. For example, each sensor pad 200 may output a variation in quantity of electric charges according to a touch of a touch input tool in response to an AC voltage alternating at predetermined frequencies. A touch detector (not shown) may measure a variation in voltage using the electric-charge-quantity variation at each sensor pad 200, and detect the touch based on the measured voltage variation.

Thus, the capacitive type touch detecting device may measure a touch area of each sensor pad based on the voltage variation. Here, the plurality of sensor pads 200 may be disposed in the front of a touchscreen in an independent polygonal shape. Accordingly, when the touch area of each sensor pad is calculated, it is possible to calculate touch coordinates on the touchscreen.

The identification pads 250 outputs a signal according to a touch in response to an AC voltage in a floating state after electric charges are charged along with the sensor pads 200. Like the sensor pads, based on the identification pads 250, a touch detector may detect a touch.

The sensor pads 200 and the identification pads 250 may be formed of a transparent conductive material. For example, the sensor pads 200 and the identification pads 250 may be formed of indium tin oxide (ITO), antimony tin oxide (ATO), carbon nanotubes (CNTs), or indium zinc oxide (IZO). The sensor pads 200 and the identification pads 250 may be formed of a metal.

The sensor pattern group 100 may include a first sensor pattern sub-group 110, a second sensor pattern sub-group 120, a first identification pad 210, and a second identification pad 220. In detail, the sensor pattern group 100 may include the first sensor pattern sub-group 110 whose sensor pads are disposed on a first axis, the second sensor pattern sub-group 120 whose sensor pads are disposed on the same first axis as the first sensor pattern sub-group 110, the first identification pad 210 that identifies a position of the first sensor pattern sub-group 110, and the second identification pad 220 that identifies a position of the second sensor pattern sub-group 120. In short, as shown in FIG. 3, the sensor pattern group 100 may include the two sensor pattern sub-groups 110 and 120, each of which includes the four sensor pads 200, and the two identification pads 210 and 220.

Here, the first sensor pattern sub-group 110 corresponds to the first identification pad 210, and the second sensor pattern sub-group 120 corresponds to the second identification pad 220. Further, the sensor pads belonging to the first sensor pattern sub-group 110 may be connected to the sensor pads that belong to the second sensor pattern sub-group 120 and correspond to the sensor pads belonging to the first sensor pattern sub-group 110. That is, the sensor pads of the first and second sensor pattern sub-groups 110 and 120 may be connected by signal wires a1, a2, a3, and a4.

For example, as shown in FIG. 3, the sensor pads located at first columns of the first and second sensor pattern sub-groups 110 and 120 may be connected by the signal wire a1. Similarly, the sensor pads located at second columns of the first and second sensor pattern sub-groups 110 and 120 may be connected by the signal wire a2.

Alternatively, the sensor pad located at the first column of the first sensor pattern sub-group 110 may be connected to the sensor pad located at a column other than the first column of the second sensor pattern sub-group 120. Thus, the connection between the sensor pads belonging to each sensor pattern sub-group and the sensor pads belonging to the other sensor pattern sub-group may be realized in various forms.

The first identification pad 210 may be connected to a touch detector (not shown) by a signal wire b1, and the second identification pad 220 may be connected to the touch detector (not shown) by a signal wire b2.

Further, the signal wires a1, a2, a3, a4, b1, and b2 may be configured so as neither to cross nor overlap one another.

Connection of the signal wires of the sensor and identification pads included in the sensor pattern group may be realized in various forms.

Further, the signal wires a1, a2, a3, a4, b1, and b2 may be formed of the same material as the sensor pads 200. For example, if the sensor pads 200 are formed of a transparent conductive material such as ITO, the signal wires a1, a2, a3, a4, b1, and b2 may also be formed of a transparent conductive material.

The sensor pads 200 may be connected to the touch detector by the signal wire a1, a2, a3, and a4, and the identification pads 250 located at the first and second identification pads 210 and 220 are connected to the touch detector by the signal wire b1 and b2, and can detect a touch.

FIG. 4 illustrates a sensor pattern group of a capacitive type touch detecting device according to yet another aspect.

A sensor pattern group 100 of a capacitive type touch detecting device according to yet another aspect is to be expanded from that shown in FIG. 3, and is similar to that shown in FIG. 3.

The sensor pattern group 100 of the capacitive type touch detecting device according to the other aspect may include a first sensor pattern sub-group 110, a second sensor pattern sub-group 120, a third sensor pattern sub-group 130, a first identification pad 210, a second identification pad 220, and a third identification pad 230. That is, as shown in FIG. 4, the sensor pattern group 100 may include the three sensor pattern sub-groups 110, 120, and 130, each of which includes four sensor pads 200, and the three identification pads 210, 220, and 230.

Here, the first sensor pattern sub-group 110 corresponds to the first identification pad 210, and the second sensor pattern sub-group 120 corresponds to the second identification pad 220. The third sensor pattern sub-group 130 corresponds to the third identification pad 230.

Further, the sensor pads 200 belonging to each of the first, second, and third sensor pattern sub-groups 110, 120, and 130 may be connected to the sensor pads belonging to the other sensor pattern sub-groups and corresponding to the sensor pad 200. Thus, the sensor pads 200 that correspond to one another in the first, second, and third sensor pattern sub-groups 110, 120, and 130 may be connected by signal wires a1, a2, a3, and a4.

In this way, the sensor pads included in the first and second sensor pattern sub-groups 110 and 120 of the sensor pattern group shown in FIG. 3 are connected, and the sensor pads located at the third sensor pattern sub-group 130 are additionally connected thereto.

For example, as shown in FIG. 4, the sensor pads located at first columns of the first, second, and third sensor pattern sub-groups 110, 120, and 130 may be connected by the signal wire a1. Alternatively, the sensor pad located at the first column of the first sensor pattern sub-group 110 may be connected to the sensor pad located at a column other than the first column of each of the second and third sensor pattern sub-groups 120 and 130. Thus, the connection between the sensor pads belonging to each sensor pattern sub-group and the sensor pads belonging to the other sensor pattern sub-groups may be realized in various forms.

The first identification pad 210 may be connected to a touch detector (not shown) by a signal wire b1, and the second identification pad 220 may be connected to the touch detector by a signal wire b2. The third identification pad 230 may be connected to the touch detector by a signal wire b3.

In this way, FIGS. 3 and 4 are based on a common technical principle, and the technology of FIG. 3 may be applied to FIG. 4 although part of the description of FIG. 4 is omitted.

FIG. 5 illustrates a sensor pattern group of a capacitive type touch detecting device according to yet another aspect.

As shown in FIG. 5, a sensor pattern group 100 of a capacitive type touch detecting device according to yet another aspect may include sensor pads 200 and identification pads 250 disposed on the same plane.

The sensor pattern group 100 of the capacitive type touch detecting device according to the other aspect may include a first sensor pattern sub-group 110, a second sensor pattern sub-group 120, a third sensor pattern sub-group 130, a fourth sensor pattern sub-group 140, a first identification pad 210, and a second identification pad 220. That is, as shown in FIG. 5, the sensor pattern group 100 may include the four sensor pattern sub-groups 110, 120, 130, and 140, each of which include four sensor pads, and the two identification pads 210 and 220.

Here, the first and third sensor pattern sub-groups 110 and 130 correspond to the first identification pad 210, and the second and fourth sensor pattern sub-groups 120 and 140 correspond to the second identification pad 220. Further, the sensor pads belonging to the first sensor pattern sub-group 110 may be connected to the sensor pads that belong to the second sensor pattern sub-group 120 and correspond to the sensor pads belonging to the first sensor pattern sub-group 110, and the sensor pads belonging to the third sensor pattern sub-group 130 may be connected to the sensor pads that belong to the fourth sensor pattern sub-group 140 and correspond to the sensor pads belonging to the third sensor pattern sub-group 130.

In detail, the sensor pads 200 that correspond to one another in the first and second sensor pattern sub-groups 110 and 120 may be connected by signal wire a1, a2, a3, and a4, and the sensor pads 200 that correspond to one another in the third and fourth sensor pattern sub-groups 130 and 140 may be connected by signal wire c1, c2, c3, and c4.

As shown in FIG. 5, the sensor pads included in the first and second sensor pattern sub-groups 110 and 120 may be connected so as to correspond to one another, and the sensor pads included in the third and fourth sensor pattern sub-groups 130 and 140 may also be connected so as to correspond to one another.

That is, the sensor pads belonging to the first and second sensor pattern sub-groups 110 and 120 are connected by the signal wire a1, a2, a3, and a4, and the sensor pads belonging to the third and fourth sensor pattern sub-group 130 and 140 may be connected by the signal wire c1, c2, c3, and c4.

The first identification pad 210 may be connected to a touch detector (not shown) by a signal wire b1, and the second identification pad 220 may be connected to the touch detector by a signal wire b2.

However, the connection between the signal wires and the sensor pads is the same as shown in FIG. 3, and may be realized in various forms.

In this case, the signal wires a1 to a4, b1 and b2, and c1 to c4 are configured so as neither to cross nor overlap one another. Further, the signal wires a1 to a4, b1 and b2, and c1 to c4 may be formed of the same material as the sensor pads 200. For example, if the sensor pads 200 are formed of a transparent conductive material such as ITO, the signal wires a1 to a4, b1 and b2, and c1 to c4 may also be formed of a transparent conductive material.

The embodiment shown in FIG. 5 is based on the embodiment shown in FIG. 3, and is a modification of the embodiment shown in FIG. 3. It is apparent that the embodiment shown in FIG. 5 may be applied to various embodiments such as the embodiment shown in FIG. 4.

The sensor pattern groups of the capacitive type touch detecting devices according to the aspects may be modified in various forms in which the sensor pattern groups shown in FIGS. 2 to 5 are rotated 90 degrees, or in which one or more sensor pattern groups are disposed in a row or column direction.

That is, the sensor pattern groups of the capacitive type touch detecting devices shown in FIGS. 2 to 5 may be configured so that the columns and the rows are switched.

FIG. 6 shows a configuration of a capacitive type touch detecting device according to yet another aspect.

Referring to FIG. 6, a capacitive type touch detecting device according to yet another aspect may include a sensor pad 200, touch capacitance Ct, parasitic capacitance Cp, drive capacitance Cdrv, a charging unit SW, and a level shift detector 300.

First, a touch detecting operation of the touch detecting device will be described.

The sensor pad 200 is an electrode patterned on a substrate in order to detect touch input, and touch capacitance Ct is formed between the sensor pad 200 and a touch input tool such as a finger or a conductor. The sensor pad 200 may be formed of a transparent conductor. For example, the sensor pad 200 may be formed of a transparent material such as ITO, ATO, CNTs, or IZO. Further, the sensor pad 200 may be formed of a metal.

The sensor pad 200 may output a signal according to a touched state of a touch input tool in response to an alternating current (AC) voltage Vdry alternating at predetermined frequencies. For example, the sensor pad 200 may output different level shift values according to whether or not a touch occurs in response to an AC voltage Vdrv.

The charging unit SW is connected to an output terminal of the sensor pad 200, and supplies a charging signal Vb. The charging unit SW may be a three-terminal switching device performing a switching operation according to a control signal supplied to an on/off control terminal, or a linear device such as an operational amplifier (OP-AMP) supplying a signal according to a control signal. The output terminal of the charging unit SW is connected to capacitors having touch capacitance Ct, parasitic capacitance Cp, and drive capacitance Cdry acting on the sensor pad 200. In a state in which the charging unit SW is turned on, the charging signal Vb is applied to an input terminal of the charging unit SW, and the capacitors having Ct, Cdrv, and Cp are charged. Then, when the charging unit SW is turned off, electric charges charged into the Ct and Cdry are isolated in a charged state as long as they are not discharged separately. In this case, to stably isolate the charged electric charges, an input terminal of the level shift detector 300 to be described below may have high impedance.

The electric charges charged into the sensor pad by turning on the charging unit SW are isolated when the charging unit SW is turned off. This isolated state refers to a floating state. The electric charges that are charged by the charging signal and are isolated between the charging unit SW and the level shift detector 300 are subjected to a variation in level of voltage by an AC signal applied from the outside. The voltage level varies according to whether or not a touch occurs. A difference between the level prior to the touch and the level after the touch refers to a level shift.

The touch detecting device may further include an AC voltage generating unit (not shown).

The AC voltage generating unit applies the AC voltage Vdry alternating at predetermined frequencies to the output terminal of the sensor pad 200 via the drive capacitance Cdrv, thereby changing a potential at the sensor pad 200. The AC voltage generating unit may generate a clock signal having the same duty ratio or an AC voltage having a different duty ratio.

A common electrode (not shown) serves as an electrode to which a common voltage is applied within a display device, and is shared within the display device. For example, a liquid crystal display (LCD) that is one of the display devices requires a common voltage to drive liquid crystals. Medium and small LCDs use an AC voltage Vdry alternating at predetermined frequencies as the common voltage in order to reduce consumption of current. Large LCDs use a direct current (DC) voltage as the common voltage.

If common electrode voltage Vcom generated from the display device is used as the AC voltage, common electrode capacitance Cvcom serves as the drive capacitance Cdrv. In this case, the drive capacitance Cdry may be temporarily removed.

Herein, the case in which the common electrode voltage is used as the AC voltage will not be separately described below. The same principle is also applied to this case, and falls within the scope of the appended claims.

The level shift detector 300 detects a level shift generated in a floating state by the AC voltage Vdrv. That is, the potential of the sensor pad is raised or lowered by the applied AC voltage Vdrv, and a variation of the voltage level caused by the touch has a lower value than that caused by no touch.

Thus, the level shift detector 300 detects the level shift by comparing the voltage levels before and after the touch. The level shift detector 300 may be configured of a combination of various devices or circuits.

For example, the level shift detector 300 may be configured of a combination of at least one of an amplifier amplifying the signal of the output terminal of the sensor pad 200, an analogue-to-digital converter (ADC), a voltage-to-frequency converter (VFC), a flip-flop, a latch, a buffer, a transistor (TR), a thin film transistor (TFT), and a comparator.

The touch detector (not shown) may detect a touch area using the level shift detected by the level shift detector 300. Here, the level shift detector 300 may be included in the touch detector or configured apart from the touch detector.

The level shift detector 300 may detect the level shift with respect to the identification pads (not shown).

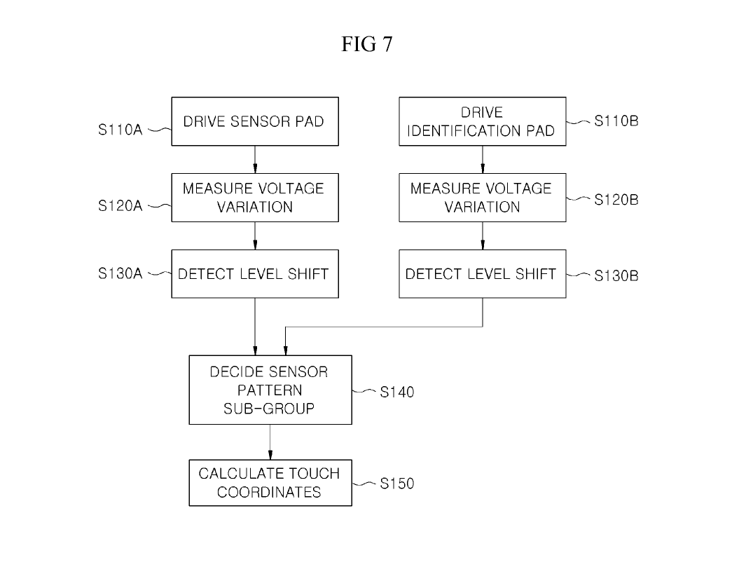

FIG. 7 is a flow chart showing a touch detecting method according to the aspect.

Referring to FIG. 7, in step S110A, the touch detecting device drives the sensor pad 200. To be specific, a charging signal Vb is applied to the output terminal of the sensor pad 200, and the capacitors such as Cdry connected to the sensor pad 200 are charged and floated. Then, an AC voltage Vdry is applied to the output terminal of the sensor pad 200.

In step S120A, the touch detecting device may measure a voltage variation. That is, the touch detecting device may measure the voltage variation at the sensor pad 200 according to whether or not a touch occurs.

In step S130A, the touch detecting device detects the level shift using the measured voltage variation. Here, the touch detecting device may be configured of a combination of various devices or circuits in order to detect the level shift.

In step S110B, the touch detecting device drives the identification pad. To be specific, a charging signal Vb is applied to an output terminal of the identification pad, and the capacitors such as Cdry connected to the identification pad are charged and floated. Then, an AC voltage Vdry is applied to the output terminal of the identification pad.

In step S120B, the touch detecting device measures a voltage variation. The touch detecting device may measure the voltage variation at the identification pad according to whether or not a touch occurs.

In step S130B, the touch detecting device detects the level shift using the measured voltage variation. Here, the touch detecting device may be configured of a combination of various devices or circuits in order to detect the level shift.

Here, when steps S110A to S130A are performed, steps S110B to S130B may be performed together.

In step S140, the touch detecting device decides a touched sensor pattern sub-group. That is, the touch detecting device decides a sensor pattern sub-group from which a touch is detected among the sensor pattern sub-groups. In this case, the touch detecting device may decide which one of the sensor pattern sub-groups is touched using the level shifts detected in steps S110A to S130A and steps S110B to S130B.

For example, which one of the sensor pattern sub-groups is touched is decided by detecting the level shift of the identification pad, and among the sensor pads belonging to the sensor pattern sub-group decided by detecting the level shift of the sensor pad, a touched sensor pad may be found. That is, the touch detecting device may find the touched sensor pad based on the detected level shifts.

In step S150, the touch detecting device may calculate touch coordinates. The touch detecting device may calculate the touch coordinates using the touch area calculated from the sensor pads belonging to the decided sensor pattern sub-group.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents. For example, the components described in a combined type may be implemented in a distributed type. Similarly, the components described in a distributed type may be implemented in a combined type.

What is claimed is:

1. A capacitive type touch detecting device, comprising:
one or more sensor pattern groups, each sensor pattern group comprising:
a first sensor pattern sub-group comprised of first sensor pads disposed on the same axis;
a second sensor pattern sub-group comprised of second sensor pads disposed on the same axis as the first sensor pattern sub-group and electrically connected to the first sensor pads;
a first identification pad for identifying a position of the first sensor pattern sub-group; and
a second identification pad for identifying a position of the second sensor pattern sub-group, the first and second sensor pads disposed on the same plane.

2. The capacitive type touch detecting device of claim 1, wherein each sensor pattern group further comprises:
a third sensor pattern sub-group comprised of third sensor pads electrically connected to the first sensor pads and disposed on the same axis as the first sensor pattern sub-group; and
a third identification pad for identifying a position of the third sensor pattern sub-group.

3. The capacitive type touch detecting device of claim 1, wherein each sensor pattern group further comprises a third sensor pattern sub-group comprised of third sensor pads and a fourth sensor pattern sub-group comprised of fourth sensor pads electrically connected to the third sensor pads; and
the first identification pad is for identifying the position of the first sensor pattern sub-group and a position of the third sensor pattern sub-group, and the second third identification pad is for identifying the position of the second sensor pattern sub-group and a position of the fourth sensor pattern sub-group.

4. The capacitive type touch detecting device of claim 1, wherein:
the first sensor pads and the second sensor pads are connected by signal wires; and
the signal wires are disposed on the same plane without crossing one another.

5. The capacitive type touch detecting device of claim 4, wherein the first sensor pads, the second sensor pads and the signal wires are formed of the same material.

6. The capacitive type touch detecting device of claim 1, wherein the first and second sensor pads, the first identification pad, and the second identification pad are formed of a transparent conductive material.

7. The capacitive type touch detecting device of claim 1, wherein each sensor pad outputs a signal according to a touched state of a touch input tool in response to an alternating current (AC) voltage alternating at predetermined frequencies in a floating state.

8. The capacitive type touch detecting device of claim 1, further comprising a touch detector that detects a touch based on a variation in voltage at each sensor pad.

9. The capacitive type touch detecting device of claim 8, wherein the first and second identification pads are electrically connected to the touch detector.
